(19) United States
(12) Patent Application Publication
(10) Pub. No.: US 2021/0239201 A1
(43) Pub. Date: Aug. 5, 2021

(54) Belt pulley decoupler

(71) Applicant: Schaeffler Technologies AG & Co. KG, Herzogenaurach (DE)

(72) Inventors: Christian Hauck, Altdorf (DE); Jens Schaefer, Herzogenaurach (DE)

(73) Assignee: Schaeffler Technologies AG & Co. KG, Herzogenaurach (DE)

(21) Appl. No.: 16/972,049

(22) PCT Filed: Jun. 11, 2019
(86) PCT No.: PCT/DE2019/100529

§ 371 Date: Dec. 4, 2020

(30) Foreign Application Priority Data
Jun. 13, 2018 (DE) 10 2018 114 078.9

(51) Int. Cl. F16H 55/36; F16D 41/20

(52) U.S. Cl. CPC F16H 55/36; F16H 2055/366; F16D 41/206

(57) ABSTRACT

A belt pulley decoupler (1) for the transfer of torque between the belt of a belt drive and a shaft (2) in drive connection therewith, includes:
a hub (5) to be fastened to the shaft,
a belt pulley (3) rotatably mounted on the hub,
and two helical torsion springs (18, 19) which transfer the torque between the belt pulley and the hub and are connected in parallel.

### CROSS-REFERENCE TO RELATED APPLICATIONS

This application is the U.S. National Phase of PCT Appin. No. PCT/DE2019/100529 filed Jun. 11, 2019, which claims priority to DE 10 2018 114 078.9 filed Jun. 13, 2018, the entire disclosures of which are incorporated by reference herein.

### TECHNICAL FIELD

The disclosure relates to a belt pulley decoupler for transfer of torque between the belt of a belt drive and a shaft in drive connection therewith, belt pulley decoupler having:
a hub to be fastened to the shaft,
a belt pulley rotatably mounted on the hub,
and two helical torsion springs which transfer the torque between the belt pulley and the hub.

### BACKGROUND

Belt pulley decouplers, which are also referred to as isolators, are found in particular in the auxiliary belt drive of an internal combustion engine to compensate for the torsional vibrations and irregularities introduced into the belt drive by the crankshaft thereof. Compensation is provided by the decoupling effect of the helical torsion springs, which, depending on the design of the belt pulley decoupler, elastically transfer the torque either from the belt pulley to the hub or from the hub to the belt pulley or in both directions. The latter embodiment is typically used in drives with a belt start-stop function by means of a starter generator which is driven by the belt in generator operation and drives the belt in motor operation.

Generic belt pulley decouplers, each with two helical torsion springs, are known from WO 2013/124 009 A1 and US 2018/0087599 A1. The helical torsion springs of these known belt pulley decouplers are connected in series.

### SUMMARY

The object of the present disclosure is to constructively improve the characteristic of the torque transfer of a belt pulley decoupler.

The helical torsion springs of the disclosed decoupler are connected in parallel. The main advantage of the belt pulley decoupler with spring parallel connection compared to series connection is that the transfer of the starting or boost torque initiated by the starter generator, which is typically five times greater than the generator torque taken off by the starter generator, is divided between two springs with comparatively low material stresses. As a result, the spring dimensioning can be optimized within the limits of an increased transfer of torque with unchanged spring tensions on the one hand and an increased spring service life with unchanged transfer of torque on the other hand.

The parallel connection of the helical torsion springs is not limited to use in belt pulley decouplers for starter generators which transfer torque in both directions of rotation. Rather, such a decoupler can also be equipped so as only to transfer generator torque from the belt to the generator and have a freewheel that allows the generator to be overrun essentially without torque. The parallel spring connection is also possible in principle with a decoupler that only transfers torque from a belt starter to the belt and has a freewheel that prevents transfer of torque in the opposite direction of torque.

### BRIEF DESCRIPTION OF THE DRAWINGS

Further features result from the following description and the figures, in which an exemplary embodiment of a belt pulley decoupler is shown. Here shown in perspective:

FIG. 1 shows the belt pulley decoupler in longitudinal section;

FIG. 2 shows the helical torsion springs designed as a spring set;

FIG. 3 shows a belt pulley-side spring plate as a single part, and

FIG. 4 shows a hub-side spring plate as a single part.

### DETAILED DESCRIPTION

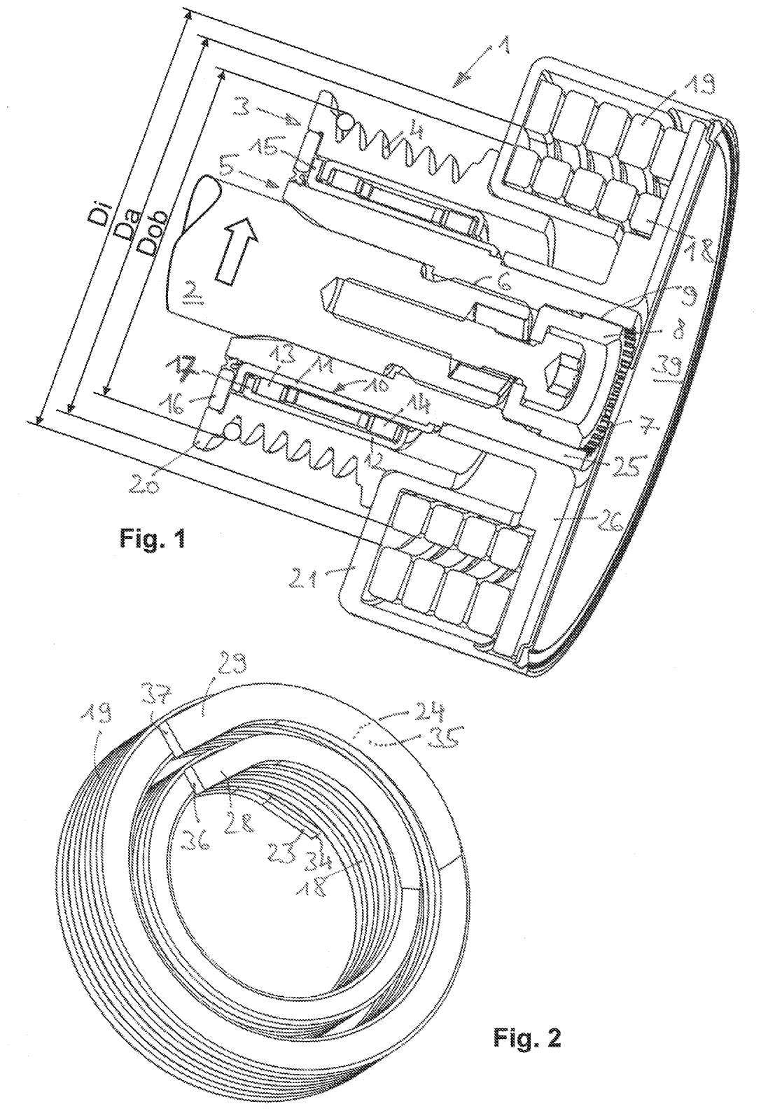

The belt pulley decoupler 1 shown in FIG. 1 is seated on the shaft 2 of a starter generator which rotates in the direction of the arrow shown. The belt pulley decoupler 1 comprises a hollow cylindrical pulley 3, the outer circumferential surface of which is wrapped by a V-ribbed belt having a corresponding poly-V profile 4 as a belt pick-up and which is rotatably mounted on a hub 5 which is firmly screwed to the shaft 2. The hub 5 has an internal thread 6 in the central section and an internal serration 7 on the front end section remote from the generator as an engagement contour for the screwing tool. After the hub 5 has been screwed on, a securing sleeve 8 with an external serration 9 corresponding to the screwing tool is inserted into the internal serration 7 and screwed to the shaft 2, so that the screw connection between the shaft 2 and the hub 5 is secured against uncontrolled loosening when the starter generator is driving.

The radial bearing of the belt pulley 3 on the hub 5 is accomplished via a double-row needle bearing 10, which is arranged in the axial region of the poly-V profile 4. The needle bearing 10 is formed with a bearing inner ring 11 pressed onto the hub 5, a bearing outer ring 12 pressed into the belt pulley 3, and two needle roller rings 13 and 14 which roll therein as a ready-to-assemble unit. The axial mounting of the belt pulley 3 on the hub 5 is accomplished via a radially outwardly extending collar 15 of the bearing inner ring 11, which on the one hand serves as a run-up for a support ring 16 pressed into the belt pulley 3 and on the other hand serves as a run-up for a radially inwardly extending collar 17 of the outer bearing ring 12.

The belt pulley decoupler 1 further comprises two parallel helical torsion springs 18 and 19 which, depending on the operating mode of the starter generator, transfer torque between the shaft 2 and the belt, wherein the spring elasticity decouples the starter generator from the torsional vibrations of the crankshaft. In the starting and boost mode, the torque is transfered from the shaft 2 to the belt via the hub 5—the helical torsion springs 18, 19—the belt pulley 3 and in generator mode from the belt to the shaft 2 via the belt pulley 3—the helical torsion springs 18, 19—the hub 5.

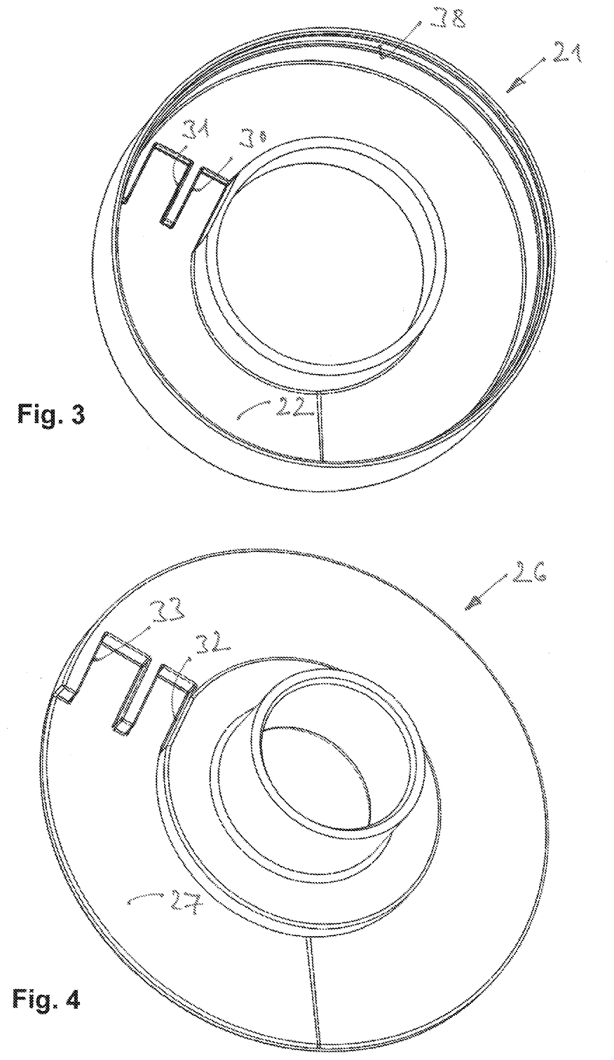

The helical torsion springs 18, 19 form the spring set shown in FIG. 2, wherein the outer helical torsion spring 19 coaxially encloses the inner helical torsion spring 18 with the same spring length and within the same axial installation space. The helical torsion springs 18, 19 are each wound from rectangular wire which is dimensioned such that the material stresses of the two helical torsion springs 18, 19 corresponding to the transferred torque are essentially of the same height. Both the inner diameter Di of the outer helical torsion spring 19 and the outer diameter Da of the inner helical torsion spring 18 are larger than the diameter Dob of the poly-V profile 4, so that the helical torsion springs 18, 19 in particular the comparatively high starting or boost torque of the starter generator can transfer sufficient fatigue strength. The diameter Dob is the test diameter of the poly-V profile 4 measured on balls (diameter over balls).

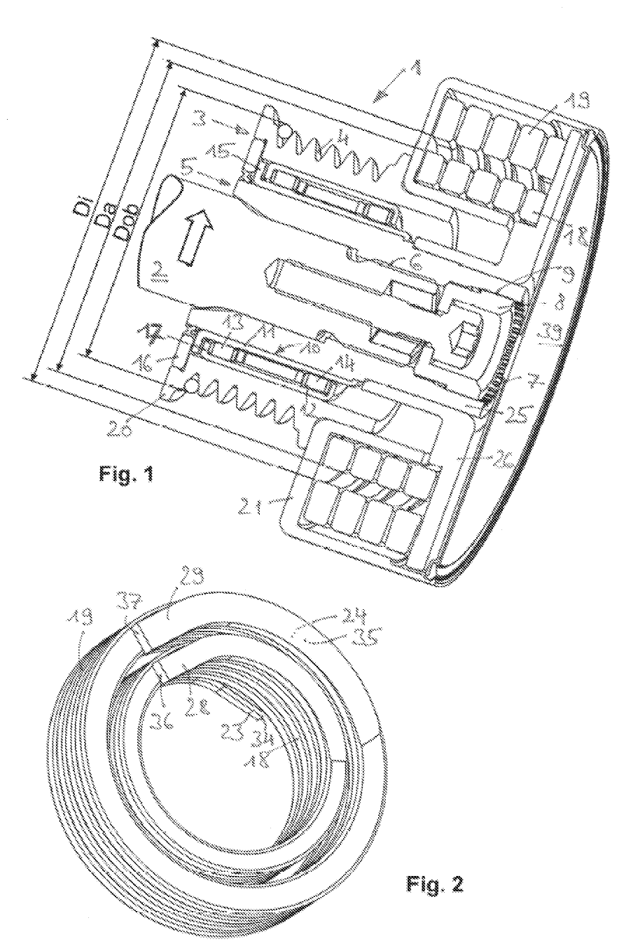

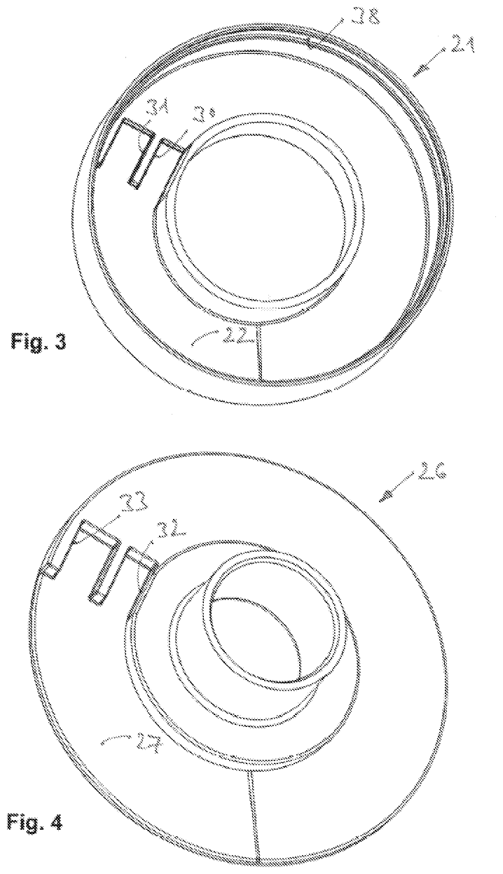

Due to the comparatively large spring diameter, the belt pulley 3 and the hub 5 are each formed of several parts. The belt pulley 3 comprises a first belt pulley part 20 with the poly-V profile 4 formed thereon and a second belt pulley part 21, which is connected in a rotationally fixed manner to the first belt pulley part 20 and which is formed as a spring plate 22 (see FIG. 3) for the helical torsion spring ends 23 and 24 running on the belt pulley 3 side during operation. The hub 5 comprises a first hub part 25 with the internal thread formed therein and a second hub part 26 connected in a rotationally fixed manner to the first hub part 25, which is designed as a spring plate 27 (see FIG. 4) for the helical torsion spring ends 28 and 29 running on the hub 5 side during operation. The helical torsion spring end 29 is identical to the helical torsion spring end 24, which is not visible in FIG. 2.

As can be seen in FIGS. 2 to 4 taken together, the winding body of the helical torsion springs 18, 19 is cylindrical in each case, wherein the helical torsion spring ends 23, 24 and 28, 29 are angled as a secant to the respective winding body and are non-rotatably suspended in the corresponding receptacles 30 and 31 or 32 and 33 of the associated spring plates 22, 27. Starting from the receptacles 30, 31 and 32, 33, both spring plates 22, 27 rise axially in a ramp-like manner corresponding to the end faces of the helical torsion springs 18, 19 to axially support the helical torsion springs 18, 19. The winding direction thereof is selected so that the starting and boost torque is transferred via the circumferential pressure contact of the receptacles 30 to 33 with the circumferential end faces 34 to 37 of the helical torsion spring ends 23, 24 and 28, 29, wherein the winding bodies of the helical torsion springs 18, 19 widen in diameter. In the opposite direction, the generator torque is transferred via the positive fit of the receptacles 30 to 33 with the helical torsion spring ends 23, 24 and 28, 29 non-rotatably suspended therein, wherein the winding bodies of the helical torsion springs 18, 19 contract in diameter.

The second belt pulley part 21, at the end thereof remote from the generator, has a stepped enlargement in diameter 38 into which a protective cap 39 is snapped after the belt pulley decoupler 1 has been screwed onto the shaft 2.

### LIST OF REFERENCE SYMBOLS

1 Belt pulley decoupler
2 Shaft
3 Belt pulley
4 Poly-V profile
5 Hub
6 Internal thread
7 Internal serration
8 Locking sleeve
9 External serration
10 Needle bearing
11 Bearing inner ring
12 Bearing outer ring
13 Needle roller ring
14 Needle roller ring
15 Collar
16 Support ring
17 Collar
18 Helical torsion spring
19 Helical torsion spring
20 First belt pulley part
21 Second belt pulley part
22 Spring plate
23 First helical torsion spring end
24 Second helical torsion spring end
25 First hub part
26 Second hub part
27 Spring plate
28 Helical torsion spring end
29 Helical torsion spring end
30 Receptacle
31 Receptacle
32 Receptacle
33 Receptacle
34 End face
35 End face
36 End face
37 End face
38 Extension
39 Protective cap

1. A belt pulley decoupler for transfer of torque between a belt of a belt drive and a shaft, having:
a hub configured to be fastened to the shaft,
a belt pulley rotatably mounted on the hub,
and inner and outer helical torsion springs which transfer the torque between the belt pulley and the hub, wherein the inner helical torsion spring has first and second torsion spring ends, the outer helical torsion spring has third and fourth torsion spring ends, and the helical torsion springs are connected in parallel.

2. The belt pulley decoupler according to claims 1, wherein the helical torsion springs transfer the torque both from the belt pulley to the hub and from the hub to the belt pulley.

3. The belt pulley decoupler according to claim 1, wherein the belt pulley has a poly-V profile as a belt pick-up, wherein the helical torsion springs are designed as a spring set and an inner diameter of the outer helical torsion spring is larger than a diameter of the poly-V profile.

4. The belt pulley decoupler according to claim 3, wherein an outer diameter of the inner helical torsion spring is larger than the diameter of the poly-V profile.

5. The belt pulley decoupler according to claim 3, wherein the belt pulley comprises a first belt pulley part on which the poly-V profile is formed, and a second belt pulley part which is connected in a rotationally fixed manner to the first belt pulley part and to which the first and third torsion spring ends are connected in a rotationally fixed manner.

6. The belt pulley decoupler according to claim 1, whererin the hub comprises a first hub part configured to be fastened to the shaft and a second hub part connected to the first hub part in a rotationally fixed manner and to which the second and fourth spring ends are connected in a rotationally fixed manner.

7. The belt pulley decoupler according to claim 1, wherein the inner and outer helical torsion springs are wound in a same direction.

8. A belt pulley decoupler comprising:
a hub configured to be fastened to a shaft,
a pulley rotatably mounted on the hub,
an inner helical torsion springs having a first end rotationally fixed to the pulley and a second end rotationally fixed to the hub, and
an outer helical torsion spring radially outside the inner helical torsion spring and wound in a same direction as the inner helical torsion spring, the outer helical torsion spring having a third end rotationally fixed to the pulley and a fourth end rotationally fixed to the hub.

9. The belt pulley decoupler according to claim 8, wherein the pulley has a poly-V profile as a belt pick-up, and an inner diameter of the outer helical torsion spring is larger than an outer diameter of the poly-V profile.

10. The belt pulley decoupler according to claim 9, wherein an outer diameter of the inner helical torsion spring is larger than the outer diameter of the poly-V profile.

11. The belt pulley decoupler according to claim 8, wherein the pulley comprises a first pulley part on which a poly-V profile is formed, and a second pulley part which is connected in a rotationally fixed manner to the first belt pulley part and to which the first and third torsion spring ends are connected in a rotationally fixed manner.

12. The belt pulley decoupler according to claim 11, wherein second pulley part includes an outer cylinder radially outside the outer helical torsion spring.

13. The belt pulley decoupler according to claim 11, wherein second pulley part includes an inner cylinder radially inside the inner helical torsion spring.

14. The belt pulley decoupler according to claim 8, wherein the hub comprises a first hub part configured to be fastened to the shaft and a second hub part connected to the first hub part in a rotationally fixed manner and to which the second and fourth spring ends are connected in a rotationally fixed manner.
